(19) United States
(12) Patent Application Publication
(10) Pub. No.: US 2026/0044178 A1
(43) Pub. Date: Feb. 12, 2026

(54) MACHINE LEARNING-BASED CLOCK GENERATION

(71) Applicant: Cisco Technology, Inc., San Jose, CA (US)

(72) Inventors: Robert Edgar Barton, Richmond (CA); Annie Tsui Tsui Ying, Vancouver (CA); Jerome Henry, Pittsboro, NC (US); Juan Carlos Zuniga, Montreal (CA)

(21) Appl. No.: 18/798,658

(22) Filed: Aug. 8, 2024

(51) Int. Cl. G06F 1/08; G06F 1/12; G06N 20/00

(52) U.S. Cl. CPC G06F 1/08; G06F 1/12; G06N 20/00

(57) ABSTRACT

Disclosed are systems, apparatuses, methods, and computer-readable media for machine learning-based clock generation. An example method includes collecting measurements from a plurality of sensors within a network device obtaining clock drift information from a machine learning (ML) model based on the measurements from the plurality of sensors and a clock signal of the network device, wherein the ML model is trained to determine a clock drift with reference to a reference clock, generating a clock correction signal to correcting the clock signal using the clock drift information, wherein the clock signal is synchronized to the reference clock based on the clock correction signal, and communicating with an external network device based on the clock signal.

### TECHNICAL FIELD

The disclosure relates generally to cloud networking and, more specifically but not exclusively, to systems and techniques for a machine learning-based clock generation.

### BACKGROUND

A precision time protocol (PTP) primary device is synchronized to a global positioning system (GPS) signal to leverage the high precision and global availability of GPS time to provide an accurate time reference for the entire network. The GPS receiver in the primary device captures the precise time signals transmitted by GPS satellites, which are then used to calibrate a reference clock. This synchronization ensures that the primary device maintains an extremely accurate time, often within nanoseconds of Coordinated Universal Time (UTC). The reference clock then disseminates this precise timing information to all connected devices within the network through the PTP protocol. By synchronizing to a GPS signal, the primary device enhances the overall time accuracy and reliability of the network, which is critical for applications requiring tight time coordination such as telecommunications, data centers, financial systems, and industrial automation.

### BRIEF DESCRIPTION OF THE DRAWINGS

In order to describe the manner in which the above-recited and other advantages and features of the disclosure may be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 is a block diagram of a networking device with a temperature-controlled crystal oscillator in accordance with some aspects of the disclosure;

FIG. 2A is a block diagram of a network device with a machine learning (ML) clock generator in accordance with some aspects of the disclosure.

FIG. 2B is a block diagram of another network device with an ML clock generator in accordance with some aspects of the disclosure.

FIG. 3 is a timeline illustrating a lifecycle of an ML clock generator in accordance with some aspects of the disclosure;

FIG. 4 is a sequence diagram illustrating training and reinforcement learning of an ML clock generator in accordance with some aspects of the disclosure.

FIG. 5 is a sequence diagram 500 illustrating training and reinforcement learning of an ML clock generator in accordance with some aspects of the disclosure;

FIG. 6 is a conceptual diagram illustrating a Siamese ML model in accordance with some aspects of the disclosure;

FIG. 7 illustrates an example method for synchronizing a network device using an ML control oscillator in accordance with some aspects of the disclosure;

FIG. 8 illustrates a block diagram of a system-on-chip (SoC) used in a network device to perform various functions in hardware in accordance with various aspects of the disclosure; and

FIG. 9 shows an example of a computing system, which may be for example any computing device that may implement components of the system.

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described to avoid obscuring the description. References to one or an embodiment in the present disclosure may be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or may be learned by practice of the herein disclosed principles. The features and advantages of the disclosure may be realized and obtained by means of the instruments and combinations particularly pointed out in the appended claims. These and other features of the disclosure will become more fully apparent from the following description and appended claims, or may be learned by the practice of the principles set forth herein.

### Overview

Precision Time Protocol (PTP), also known as the IEEE 1588 standard, is a network protocol used to synchronize clocks throughout a network. PTP provides extremely precise time coordination to achieve accuracy in the sub-microsecond range for applications that require exact timing. PTP operates by exchanging timing messages between a leader clock that provides a reference and follower clocks to allow the follower clocks to adjust their time to match the reference clock. Synchronization is achieved through a series of messages that measure and correct for delays introduced by the network.

PTP is particularly valuable in fields such as telecommunications and ensures that data packets are transmitted at the correct times to avoid collisions and maintain a quality of service (QoS). PTP is also used in other industries such as financial, military, and industrial applications. For example, the finance industry employs PTP to timestamp transactions and ensure the integrity and sequence of trades. Industrial automation systems rely on PTP to synchronize operations of distributed systems to enhance efficiency and coordination.

The synchronization of PTP with Layer 2 network devices is crucial for maintaining high precision and accuracy in time-sensitive applications. Layer 2 devices, such as switches and bridges, operate at the data link layer of the OSI model and handle the direct transfer of data between nodes on the same network segment. When PTP is synchronized with these devices, the synchronization minimizes the delay and jitter inherent in data transmission and ensures that timing information is accurately propagated throughout the network. This synchronization is essential for applications like high-frequency trading, where even microsecond discrepancies can have significant financial implications, and in telecommunications, where synchronized data streams are necessary for maintaining call quality and data integrity. By ensuring that Layer 2 devices are accurately synchronized, PTP enhances network performance, reliability, and the precise coordination required for critical operations in various industries.

Network devices that implement PTP may include a temperature-compensated crystal oscillator (TCXO) to provide accurate timing to other components of the network device. A TCXO is a crystal oscillator that includes a temperature control mechanism designed to provide highly stable frequency output across a wide range of temperatures to prevent physical variations that manifest into electrical variations.

A TCXO is an expensive addition to a network device due to various factors. First, manufacturing a TCXO require precision engineering and materials that contribute significantly to its cost. The manufacturing process includes selecting high-quality quartz crystals and incorporating sophisticated temperature compensation circuitry, which adds to the manufacturing complexity. Additionally, TCXOs undergo rigorous testing and calibration to meet stringent performance standards, further increasing production costs. The benefits of enhanced stability and accuracy must be weighed against these higher costs, often making TCXOs a premium choice in network equipment. Consequently, network devices that include TCXOs are typically more expensive but offer superior performance in environments where precise timing is critical.

Systems, apparatuses, processes (also referred to as methods), and computer-readable media (collectively referred to as “systems and techniques”) are described herein for machine learning (ML)-based clock generation. In some aspects, an ML clock generator is disclosed that is trained to maintain synchronization of clock signals with reference to a reference clock from a primary network device. The ML clock generator may be uninitialized when brought online (e.g., by a network vendor who installed a network device including the ML clock generator), and the ML clock generator may be trained during an initialization period based on performance information and measurements from various sensors (e.g., a temperature sensor, a humidity sensor, etc.).

An example method includes collecting measurements from a plurality of sensors within a network device; obtaining clock drift information from a machine learning (ML) model based on the measurements from the plurality of sensors and a clock signal of the network device, generating a clock correction signal to correcting the clock signal using the clock drift information, and communicating with an external network device based on the clock signal. In some aspects, the ML model causes an oscillator or a clock generator connected to an oscillator to generate signals that are synchronized with the reference clock of the primary network device.

The ML clock generator may also include reinforcement learning to further train the ML model during the lifecycle of the network device. For example, performance of various components of the network device changes over time, and the ML clock generator may continue to monitor the network device, synchronize with the primary network device, and further train the ML model based on clock drift. As an example, the primary network device can determine rewards based on a clock drift and the length of interval associated with the clock drift to iteratively modify the ML model over time and ensure that the ML model also changes with the network device.

The ML model can enable the network device to achieve tight synchronization with the reference clock from the primary network device without the need for a TCXO, thereby reducing components and corresponding costs, and reducing manufacturing processes of assembling devices.

Various aspects of the application will be described with respect to the figures.

### Example Embodiments

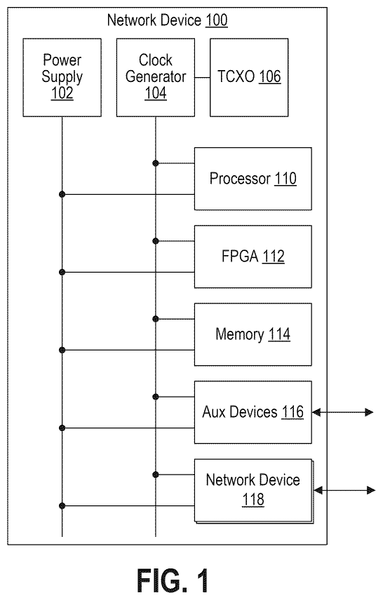

FIG. 1 is a block diagram of a network device 100 with a TCXO in accordance with some aspects of the disclosure. In some aspects, the network device 100 includes a power supply 102 that provides various power sources to each device, a clock generator 104, and a TCXO 106 that provides a temperature-controlled clock to the clock generator 104.

In some aspects, the clock generator 104 is configured to generate different clock signals based on the TCXO 106. The clock generator 104 uses the TXCO reference to produce various clock signals at different frequencies and phases required by different subsystems within the network device 100. This functionality is essential in complex electronics, such as communication systems, microprocessors, and network equipment, where multiple components operate at different frequencies but need to stay synchronized. By leveraging a single high-quality oscillator input from the TCXO 106, the clock generator 104 ensures coherent and reliable timing across the network device 100.

For example, the network device 100 includes many other components and systems, such as a processor 110 to provide general control, a field programmable gate array (FPGA) 112 that is configured to provide hardware-level performance for specific functions (e.g., pattern matching, encryption, decryption, header inspection, etc.), a memory 114, at least one auxiliary device 116 configured to interact with external components (e.g., a universal serial bus (USB) controller, a thunderbolt controller, etc.), and at least one network device 118 (also referred to a network interface or a network interface card (NIC). Each of the processor 110, the FPGA 112, the memory 114, the auxiliary device 116, and the network device 118 may require different clocks and different requirements for those clocks. Based on using a TCXO 106 in combination with the clock generator 104, the clock generator 104 can generate clock signals that comport with each device and ensure that all devices are synchronized.

In some aspects, the network device 100 can include other devices that are omitted for simplicity. For example, the network device 100 can include various sensors, input/output interfaces, wireless networking components (e.g., 802.11 communication modules, Bluetooth™ communication modules, etc.), and so forth.

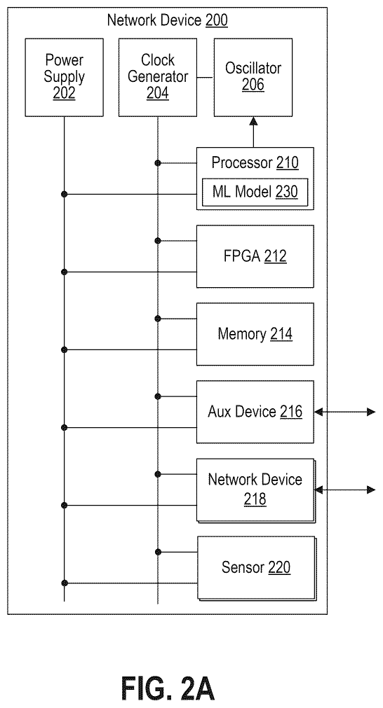

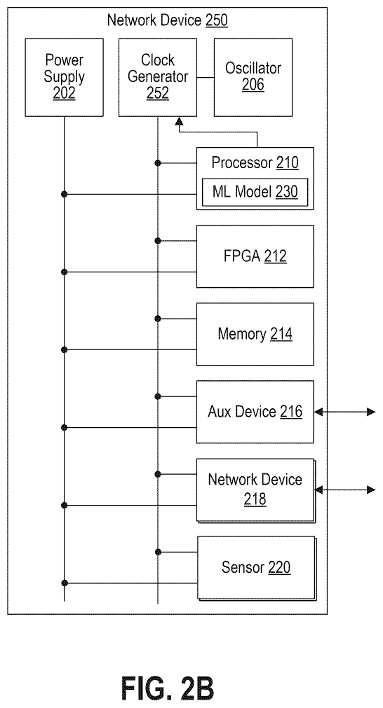

FIG. 2A is a block diagram of a network device 200 with a machine learning (ML) clock generator in accordance with some aspects of the disclosure. In some aspects, the network device 200 includes a power supply 202 that provides various power sources to each device, a clock generator 204, and an oscillator 206 (e.g., a crystal oscillator, etc.).

The network device 200 includes many other components and systems, such as a processor 210 to provide general control of the network device 200, an FPGA 212, a memory 214, at least one auxiliary device 216 configured to interact with external components (e.g., a USB controller, a thunderbolt controller, etc.), and at least one network interface 218.

The network device 200 also includes a plurality of sensors 220 for detecting physical aspects of the network device 200. For example, the plurality of sensors 220 can include a temperature sensor for monitoring an internal temperature of different aspects of the network device 200 (e.g., an integrated circuit, the processor 210, the FPGA 212, etc.), a voltage sensor (or current sensor) for detecting power fluctuations or power issues that could affect performance, a humidity sensor for monitoring humidity levels inside the network device 200, a fan speed sensor, an optical sensor for measuring integrity and performance of optical signals, a motion sensor (e.g., a gyrometer) for detecting vibrations and other abrasive movement, photosensors for detecting ambient light, and environmental sensors (e.g., a temperature sensor, a humidity sensor) for detecting ambient environmental conditions such as ambient temperature and humidity.

The network device 200 can also record internal processing information in conjunction with the measured sensor data to provide rich data. For example, the network device 200 may record processor load, thread counts, stack and/or heap information, memory usage, cache statistics, and other internal metrics that can be correlated with sensor information.

In some aspects, an ML clock generator is a combination of ML functions and hardware components (e.g., the oscillator 206) to provide synchronization comparable to a TCXO but without additional hardware. In particular, the processor may use an ML model 230 that is trained to use various measurements from the sensor 220 and determine clock information that is provided to the oscillator 206. For example, the processor 210 may record measurements from the sensors 220 as a time series and provide the different measurements into the ML model 230.

The ML model 230 provides clock information to the oscillator 206 for correcting any deviations and keeping the oscillator 206 in synchronization with an external reference clock. For example, the ML model 230 can identify a phase offset to apply over a period of time that corrects a phase difference between the oscillator 206 and the reference clock. The ML model 230 may cause the oscillator 206 to slowly shift the phase forward or backward to prevent phase noise. The ML model 230 can cause the processor to, for example, control a voltage, a load capacitance, or other aspect of the oscillator 206 to change the frequency of the oscillator 206 without introducing additional noise or other artifacts.

In some aspects, the ML model 230 is trained based on an installed environment of the network device 200. For example, the ML model 230 may be uninitialized when installed and is trained during an initialization period. During the initialization period, the network device 200 may communicate with an external device to receive reference clock information. As loads and environmental conditions vary over time, the network device 200 continues to record sensor measurements and clock drift with respect to the reference clock. The network device 200 may be configured to train the ML model 230 during the initialization period using a training engine, and can dynamically adapt time periods during which the network device 200 may receive the reference clock information. For example, during peak traffic, the oscillator 206 of the network device 200 may significantly drift based on increased processing and temperature, and the network device 200 can increase the volume of synchronization requests to ensure that the network device 200 is synchronized, as well as to learn other patterns based on large volumes of data. As the network device 200 records more data, the network device 200 can backpropagate and train the ML model 230. In one illustrative example, the ML model 230 may be trained using a Siamese ML model.

During the training period, the ML model 230 is in a supervised state and the external reference clock (e.g., a base station synchronized with a global positioning system (GPS) signal) may provide the ground truth. In some cases, the network device 200 may be configured to validate the ML model 230 based on requirements associated with the network device and/or the network operator. For example, a network operator may require a minimal clock deviation of 0.001% per hour, and the ML model 230 continues training until that clock deviation can be obtained over an extended period (e.g., 7 days). In some cases, the deviation may be less stringent due to the network device 200 being installed in a controlled environment such as a data center, for example, or may have less stringent jitter requirements.

After the initialization period is deemed to be over based on training, the network device 200 may enter a maintenance period during which the ML model can handle monitoring and adjusting of the oscillator 206 to maintain synchronization with the reference clock and provide the ground truth of the reference clock. The ML model 230 is configured to learn how to mirror the reference clock based on the hardware of the network device 200 and its environment (e.g., processing load, temperature, humidity, etc.).

In one aspect, the network device 200 may be configured to apply reinforcement learning to the ML model 230. For example, the network device 200 may continue to check the external reference clock and may perform reward-based learning to further train the ML model 230 based on its inferences between synchronization intervals. The network device 200 may periodically check the reference clock based on dynamic intervals and provide rewards corresponding to the duration of the interval. For example, the longer the duration between synchronization with the external reference and a service level agreement (SLA), the network device 200 may determine a corresponding award based on inference operation that keeps the network device 200 synchronized based on the time between synchronization events with the reference clock (e.g., the reward corresponds to the accuracy of the ML model 230 inference scaled by the duration that the ML model 230 drifts between synchronizations).

FIG. 2B is a block diagram of another network device 250 with an ML clock generator in accordance with some aspects of the disclosure. In some aspects, the network device 200 includes a power supply 202 that provides various power sources to each device, a clock generator 252, and an oscillator 206 (e.g., a crystal oscillator, etc.). The network device 250 is similar to network device 200 but includes a clock generator 252 receives the clock information that synchronizes the generation of clock signals based on the oscillator 206 and the clock information from the processor 210. In this case, the oscillator 206 does not require any specific hardware or functionality, and the corrective actions to address any clock drift can be performed by specific hardware within the clock generator 252. In this case, the clock generator 252 maintains hardware such as a memory and circuit hardware that can adjust generated signals (e.g., a delay) separate from the oscillation signal.

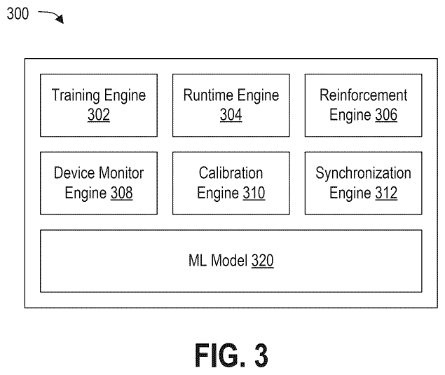

FIG. 3 is a conceptual diagram of components of an ML clock engine 300 in accordance with some aspects of the disclosure. In some aspects, the ML clock engine can be instructed executed by the processor 110 or other hardware components (e.g., an FPGA, an application specific integrated circuit (ASIC), a system-on-chip (SoC), etc.) to train and maintain an ML Model.

The ML clock engine 300 includes a training engine 302 for training an ML model 320. For example, the ML model 320 may be provided with initial weights during manufacturing and the training engine 302 is configured to execute during an initialization period to train the training engine 302. In one case, the training engine 302 may backpropagate to minimize the error by adjusting the weights of the ML model 320 using a gradient of the loss function with respect to each weight. In another example, the training engine 302 may include a Siamese ML model for training the weights based on online operation of the network device. During the initialization period, the training engine 302 may provide instructions to a runtime engine 304 that controls the operation of the network device. For example, the training engine 302 may instruct the runtime engine 304 to follow an external reference clock, which causes the runtime engine 304 to synchronize with a reference device. In this case, during the initialization period, the network device including the ML clock engine 300 may synchronize with the external reference clock on a frequent basis, record synchronization information and measurement data of the network device as time series data, and train the ML model 320 based on the time series data.

The ML clock engine 300 also includes a reinforcement engine 306 that is configured to perform reinforcement learning on the ML model 320 during a maintenance period (e.g., after the initialization period has ended). During the maintenance period, the ML model 320 provides the ground truth of the reference clock based on inference using the measurements. The reinforcement engine 306 is configured to monitor the synchronization of the ML model 320 with reference to the external clock reference and provide additional training (e.g., using rewards) to the ML model 320. In this aspect, the network device including the ML clock engine 300 is monitored for changes in the environment and can continue to learn as it ages because physical effects of aging, heating/cooling cycles, air flow variation, mechanical vibration, and other changes affect the electrical performance of the oscillator, power supply, and other components that affect the totality of the operation. The reinforcement engine 306 can counter the effects of these long-term changes based on continued operation based on comparing inference information from the ML clock engine 300 to the external clock reference The ML clock engine 300 also includes a device monitor engine 308 to collect and store measurement data from the various sensors of the network device. For example, as noted above, the device monitor engine 308 can store the various measurements as time series data and may include various functions such as normalization, interpolation, and other functions to clean data for training and reinforcement. The ML clock engine 300 also includes a calibration engine 310 for managing calibration of the various measurements, such as identification of incorrect data, or providing alerts that the calibration of a sensor may be invalid. For example, the calibration engine may be configured to modify measurements to reduce the accuracy of measurements based on a time duration after an initial calibration of the sensor. Calibration of a sensor varies over time, and modification of the measurements can inject uncertainty to prevent the inference performance of the ML model 320 from having false confidence.

The ML clock engine 300 may also include a synchronization engine 312 for identifying synchronization issues internally within the network device and externally with the reference clock. For example, the synchronization engine 312 may identify that a particular network interface (e.g., the network interface 218) is semi-persistently delayed due to internal component degradation based on frequent errors from another peer network device. As an example, a capacitor can vary with age, which can cause the timing to be affected by only that particular network interface. The synchronization engine 312 may be configured to identify individual synchronization issues based on the number of errors and raise alerts, log errors, or provide other information.

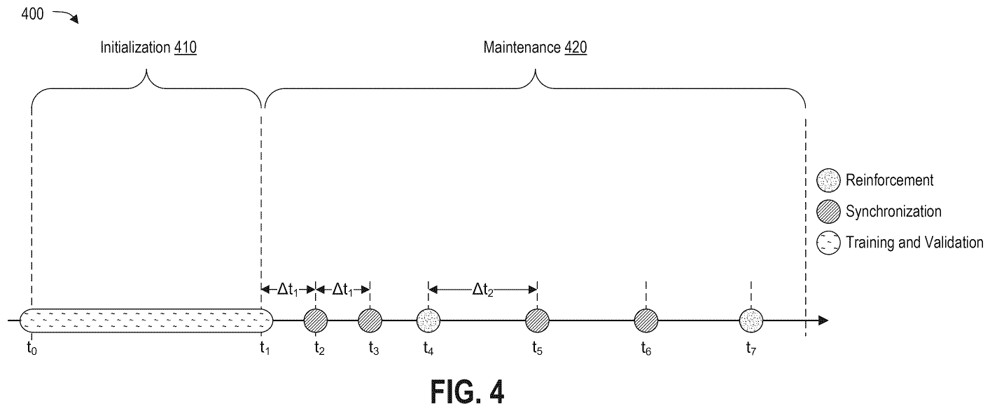

FIG. 4 is a timeline 400 illustrating the lifecycle of an ML clock generator in accordance with some aspects of the disclosure. The timeline 400 illustrates that a network device that includes an ML clock generator includes an initialization period 410 during which the network device undergoes training and validation. As described above, during the initialization period 410, the ground truth of the clock for the network device is based on an external reference.

Once the ML model of the network device is validated, the network device enters a maintenance period 420 during which the ML model provides the ground truth of the external reference. During the maintenance period 420, the ML model synchronizes with the external reference on a dynamic interval that changes based on the confidence of the inference operation. For example, initially, the ML model performs synchronization with the external clock reference on a first time interval Δt1, but as the confidence of the inference operation increases based on time, the ML model performs synchronization with the external clock reference on a second time interval Δt2 that is greater than the first time interval Δt1. During the maintenance period 420, the ML model also undergoes additional reinforcement learning to improve inference operation based on the performance of the ML model.

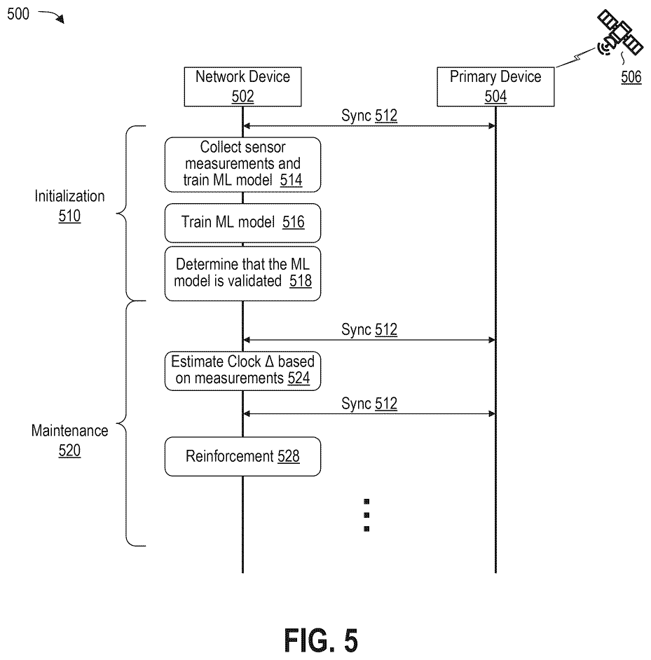

FIG. 5 is a sequence diagram 500 illustrating training and reinforcement learning of an ML clock generator in accordance with some aspects of the disclosure. In some aspects, a network device 502 may be brought online and includes an ML clock generator for synchronizing with a primary device 504 that provides a reference clock. In one aspect, the primary device 504 derives the reference clock based on GPS signals from one or more satellites 506. The reference clock of the primary device 504 provides precise timing information to all connected devices within the network through the PTP protocol and, by synchronizing to a GPS signal, enhances the overall time accuracy and reliability of the network. The devices synchronized with the primary device 504 are able to synchronize and reduce jitter, latency, and retransmissions to improve service to downstream devices.

During an initialization period 510, the network device 502 and the satellites 506 are configured to exchange synchronization information 512. In addition, the network device 502 is configured to measure environmental information (e.g., temperature, humidity, fan speed, ambient light, etc.) and performance information (e.g., memory usage, processor usage, threads, stack/heap information, etc.) of the network device 502 at block 514. At block 516, the network device 502 is configured to train the ML model based on the synchronization information 512, the environmental information, and the performance information. At block 518, the network device 502 determines that the ML model is validated (e.g., by maintaining an oscillator within a particular threshold without requiring to use of the synchronization information 512 to update the oscillator for a period of time).

After validation at block 518, the network device 502 enters the maintenance period 520 during which the network device 502 receives the exchange synchronization information 512. Based on the exchange synchronization information 512, at block 524, the network device 502 may estimate a clock drift based on sensor measurements, a duration between synchronization, and so forth. At block 524, the network device 502 builds information that identifies potential inferences that may have been inaccurate. The network device 502 continues to receive the synchronization information on a dynamic basis, and then can apply the measurements and sensor measurements at block 528 for reinforcement learning. For example, the network device 502 can generate rewards based on the clock drift, the duration between the synchronization with the primary device 504, and then apply reinforcement learning to the ML model. In this case, the network device 502 learns scenarios during which inference was inaccurate and can learn probabilistic behavior that mirrors the reference clock at the primary device 504 based on the environment and load of the network device 502.

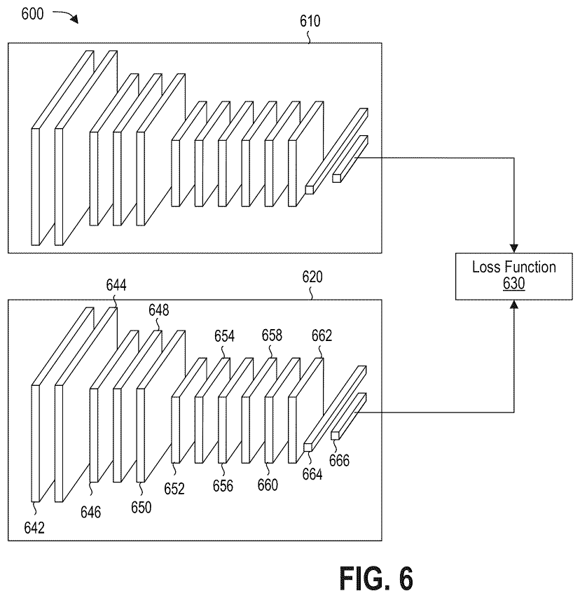

FIG. 6 is a conceptual diagram illustrating an ML model 600 in accordance with some aspects of the disclosure. In some aspects, the ML model 600 has a Siamese configuration (also referred to as a Siamese Neural Network (SNN)) and is designed for comparing two inputs and determining a similarity. The Siamese ML model includes a first subnetwork 610 and a second subnetwork having an identical architecture. The first subnetwork 610 and the second subnetwork 620 receive input and outputs are combined to compute a similarity score. In this manner, the ML model 600 is able to learn meaningful representations that capture essential features of the inputs and identify actions to take to converge the ML model 600 to a standard state. For example, the ML model 600 can use sensor information to train an ML model for controlling an oscillator to be synchronized with a reference clock.

In one aspect, time series data of sensor measurements and clock data (e.g., offset and phase) can be input into the first subnetwork 610, and the second subnetwork 620 can receive a reference clock data to learn how the variations in the sensor measurements change clock operation. For example, thermal generation and heat dissipation vary over time and the ML model 600 can learn how different sensors, different thermal dissipation (e.g., power consumption), and physical factors affect the clock.

Training a Siamese Neural Network involves presenting pairs of inputs to the network, with each pair labeled as similar or dissimilar. The loss function, often a contrastive loss or triplet loss, is designed to minimize the distance between similar pairs and maximize the distance between dissimilar pairs in the output space. This approach helps the network learn a robust embedding space where similar inputs are close together, and dissimilar inputs are far apart. Applications of Siamese networks extend beyond verification tasks to include one-shot learning, where the network can recognize new classes from a single example, and metric learning, where the network learns a distance function that can be used in various downstream tasks. The architecture is versatile and able to generalize from limited data make based on a comparison of inputs.

In some aspects, the each of the first subnetwork 610 and the second subnetwork 620 include an 11×11 convolution and ReLu layer 642 followed by a normalization 644, a max pooling layer 646, an 6×5 convolution and ReLu layer 648 followed by a normalization 650, a max pooling layer 652, a dropout layer 654, a 3×3 convolution layer 656 (384 kernels), another 3×3 convolution layer 658 (256 kernels), a max pooling layer 660, a dropout 662, a fully connected layer 664 with ReLu and dropout, and a fully connected layer 666 with ReLu.

As noted above, a network device may train the ML model 600 online (e.g., during runtime operation) during an initialization period. A Siamese ML model can use an external reference clock and measurement data (e.g., temperature, humidity, load, time, season, ambient light, etc.) and learn how the measurement data causes an oscillator or a clock generator to vary based on a combination of the device itself and its operating environment. For example, the first subnetwork 610 can receive the reference clock and the second subnetwork 620 can receive sensor data, which can cause the learning of the second subnetwork 620 to mirror the reference clock based on a loss function 630. In this manner, the Siamese ML model learns how to mirror the reference clock based on its environment and its own internal variations. After training, the weights learned by the ML model 600 can be used for inference.

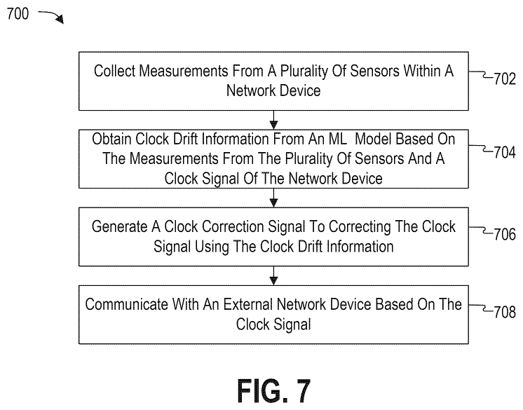

FIG. 7 illustrates an example method 700 for synchronizing a network device using an ML control oscillator in accordance with some aspects of the disclosure. Although the example method 700 depicts a particular sequence of operations, the sequence may be altered without departing from the scope of the present disclosure. For example, some of the operations depicted may be performed in parallel or in a different sequence that does not materially affect the function of the method 700. In other examples, different components of an example device or system that implements the method 700 may perform functions at substantially the same time or in a specific sequence. Although a computing device (e.g., using the SoC 800, etc.) is described as performing the method, this example is for descriptive purposes.

In some aspects, the ML model is untrained when the network device is brought online before an initialization period. For example, when the network device is activated, the ML model is untrained based on the environment and its own hardware variations. Accordingly, the computing system may perform training operations in conjunction with normal operation. The computing system may be configured to receive validation information from a control plane or an end user, and the validation information includes at least one parameter that indicates that the ML model has completed an initialization period. That is, a network administrator or some other control plane component can determine the precise requirements of the ML model.

At block 702, the computing system may collect measurements from a plurality of sensors within a network device. Non-limiting examples of a sensor include at least one of a temperature sensor for detecting a temperature within the network device, a temperature sensor for detecting the ambient temperature of an environment, an acceleration sensor, and a humidity sensor. The computing system can also collect operational information of the computing system (e.g., processor load, memory usage, thread information, stack/heap information, etc.).

At block 704, the computing system may obtain clock drift information from an ML model based on the measurements from the plurality of sensors and a clock signal of the network device. The ML model is trained to determine a clock drift with reference to a reference clock, and the reference clock is provided by a primary network device that determines the reference clock based on at least one signal from at least one satellite (e.g., using GPS signals). In one non-limiting example, the ML model is trained using a Siamese training network. The weights learned by the ML model during training are used in an ML model during inference.

At block 706, the computing system may generate a clock correction signal to correct the clock signal using the clock drift information. In this case, the clock signal is synchronized to the reference clock based on the clock correction signal. For example, the computing system may provide the clock correction signal to a local oscillator to synchronize the local oscillator with respect to the reference clock. In this example, the clock correction signal controls hardware within the local oscillator such that the oscillator signal is synchronized with a clock generator circuit. In another example, the computing system may provide the clock correction signal to a clock generator to synchronize at least one clock signal to the reference clock. In this case, the local oscillator remains out of sync with the reference clock, but the clock generator circuit tracks a drift and provides error correction within its circuitry to correct one or more clock signals generated therein.

The computing system may, after the initialization period, receive synchronization information of the reference clock on an interval. For example, the computing system can request the reference clock from the primary network device using PTP and receive synchronization information that would cause the clock of the computing system to correspond to the primary network device. The synchronization information can identify a clock drift expressed in various units (e.g., phase, time, etc.). The computing system may determine a clock drift between the reference clock and the clock signal. In some aspects, the computing system may determine a reward for the ML model based on the clock drift and a duration between synchronizations. The computing system may then train (e.g., reinforcement training) the ML model based on the reward. The reinforcement training can also include sensor measurements and performance information to assist the ML model to learn events that may have caused the drift.

At block 708, the computing system may communicate with an external network device based on the clock signal. For example, the external network device can also be synchronized with the primary network device and, based on the mutual synchronization, can provide high-bandwidth communication with low latency while minimizing jitter. Synchronization reduces the overhead of communication and enables more efficient bandwidth usage.

The ML model can provide highly accurate clock correction with reference to a primary network device that is synchronized to an extraterrestrial time source without requiring expensive temperature-controlled hardware. Temperature controlled hardware is expensive, adds a potential fault that can render the device inoperative, and also consumes additional power to maintain internal components at a consistent temperature.

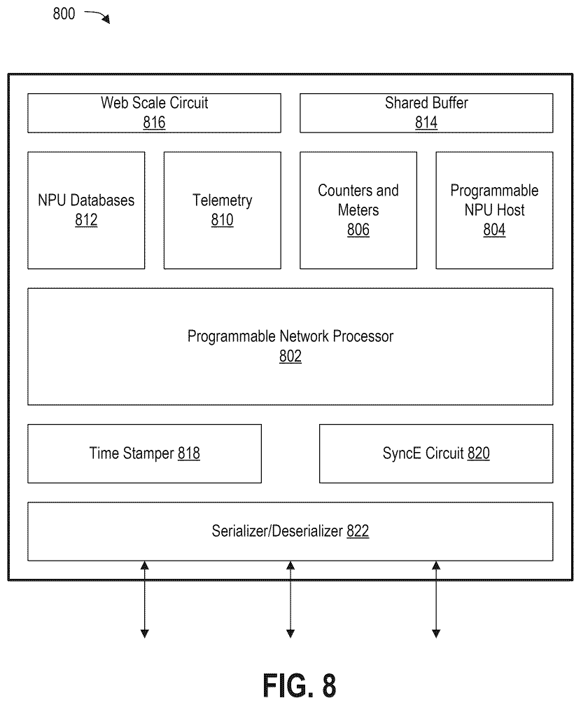

FIG. 8 illustrates a block diagram of an SoC 800 in a network device to perform various functions in hardware in accordance with various aspects of the disclosure. For example, the SoC 800 may include fixed hardware components and programmable hardware components to perform various network tasks. In one illustrative aspect, the SoC 800 includes a programmable network processor 802 (e.g., a network processing unit (NPU), etc.), a programmable NPU host 804, counters and meters 806, telemetry 810, an NPU database 812, a shared buffer 814, a web scale circuit 816, a time stamper 818, a synchronous Ethernet (SyncE) circuit 820, and a serializer/deserializer 822. In some cases, the SoC 800 may be configured to execute bytecode instructions to be supplemented with additional functions. For example, the SoC 800 may be configured to execute various functions described above.

The programmable network processor 802 may be programmed to perform functions that are conventionally performed by integrated circuits (IC) that are specific to switching, routing line card, and routing fabric. The programmable network processor 802 may be programmable using the programming protocol-independent packet processors (P4) language, which is a domain-specific programming language for network devices for processing packets. The programmable network processor 802 may have a distributed P4 NPU architecture that may execute at a line rate for small packets with complex processing. The programmable network processor 802 may also include optimized and shared NPU fungible tables. In some aspects, the programmable network processor 802 supports a unified software development kit (SDK) to provide consistent integrations across different network infrastructures and simplifies networking deployments. The SoC 800 may also include embedded processors to offload various processes, such as asynchronous computations.

The programmable network processor 802 includes a programmable NPU host 804 that may be configured to perform various management tasks, such as exception processing and control-plane functionality. In one aspect, the programmable NPU host 804 may be configured to perform high-bandwidth offline packet processing such as, for example, operations, administration, and management (OAM) processing and medium access control (MAC) learning.

The SoC 800 includes counters and meters 806 for traffic policing, coloring, and monitoring. As an example, the counters and meters 806 include programmable counters used for flow statistics and OAM loss measurements. The programmable counters may also be used for port utilization, microburst detection, delay measurements, flow tracking, elephant flow detection, congestion tracking, etc.

The telemetry 810 is configured to provide in-band telemetry information such as per-hop granular data in the forwarding plane. The telemetry 810 may observe changes in flow patterns caused by microbursts, packet transmission delay, latency per node, and new ports in flow paths. The NPU database 812 provides data storage for one or more devices, for example, the programmable network processor 802 and the programmable NPU host 804. The NPU database 812 may include different types of storage, such as key-value pair, block storage, etc.

In some aspects, the SoC 800 includes a shared buffer 814 that may be configured to buffer data, configurations, packets, and other content. The shared buffer 814 may be utilized by various components such as the programmable network processor 802 and the programmable NPU host 804. A web scale circuit 816 may be configured to dynamically allocate resources within the SoC 800 for scale, reliability, consistency, fault tolerance, etc.

In some aspects, the SoC 800 may also include a time of day (ToD) time stamper 818 and a SyncE circuit 820 for distributing a reference to subordinate devices. For example, the time stamper 818 may support IEEE-1588 for ToD functions. In some aspects, the time stamper 818 includes support for PTP for distributing frequency and/or phase to enable subordinate devices to synchronize with the SoC 800 for nano-second level accuracy.

The serializer/deserializer 822 is configured to serialize and deserialize packets into electrical signals and data. In one aspect, the serializer/deserializer 822 supports sending and receiving data using non-return-to-zero (NRZ) modulation or pulse amplitude modulation 4-level (PAM4) modulation. In one illustrative aspect, the hardware components of the SoC 800 provide features for terabit-level performance based on flexible port configuration, nanosecond-level timing, and programmable features. Non-limiting examples of hardware functions that the SoC 800 may support include IP tunneling, multicast, network address translation (NAT), port address translation (PAT), security and QoS access control lists (ACLs), equal cost multiple path (ECMP), congestion management, distributed denial of service (DDos) migration using control plane policing, telemetry, timing and frequency synchronization, and so forth.

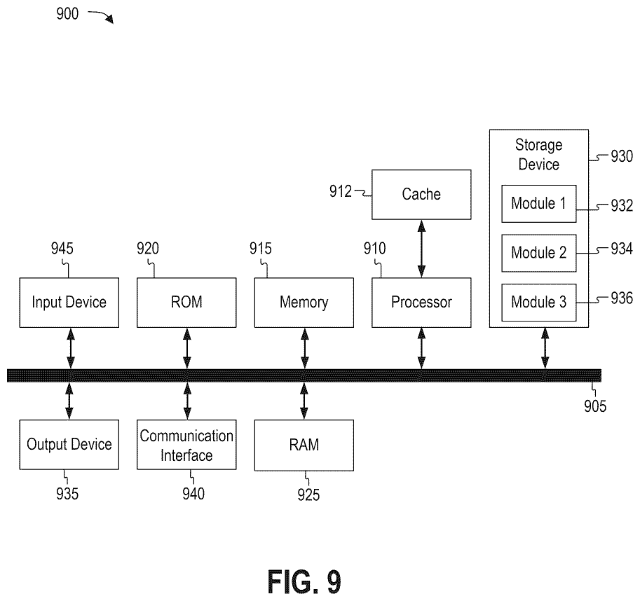

FIG. 9 is a diagram illustrating an example of a system for implementing certain aspects of the present technology. In particular, FIG. 9 illustrates an example of computing system 900, which can be for example any computing device making up internal computing system, a remote computing system, a camera, or any component thereof in which the components of the system are in communication with each other using connection 905. Connection 905 can be a physical connection using a bus, or a direct connection into processor 910, such as in a chipset architecture. Connection 905 can also be a virtual connection, networked connection, or logical connection.

In some aspects, computing system 900 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example computing system 900 includes at least one processing unit (a central processing unit (CPU) or processor) 910 and connection 905 that couples various system components including system memory 915, such as ROM 920 and RAM 925 to processor 910. Computing system 900 can include a cache 912 of high-speed memory connected directly with, in close proximity to, or integrated as part of processor 910.

Processor 910 can include any general purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms. In some instances, multimodal systems can enable a user to provide multiple types of input/output to communicate with computing system 900. Computing system 900 can include communications interface 940, which can generally govern and manage the user input and system output. The communication interface may perform or facilitate receipt and/or transmission wired or wireless communications using wired and/or wireless transceivers, including those making use of an audio jack/plug, a microphone jack/plug, a USB port/plug, an Apple® Lightning® port/plug, an Ethernet port/plug, a fiber optic port/plug, a proprietary wired port/plug, a Bluetooth® wireless signal transfer, a Bluetooth low energy (BLE) wireless signal transfer, an IBEACON® wireless signal transfer, an radio frequency identifier (RFID) wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another IC chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 930 can include software services, servers, services, etc., that when the code that defines such software is executed by the processor 910, it causes the system to perform a function. In some aspects, a hardware service that performs a particular function can include the software component stored in a computer-readable medium in connection with the necessary hardware components, such as processor 910, connection 905, output device 935, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some examples, the processes described herein (e.g., method 700, and/or other process described herein) may be performed by a computing device or apparatus. In one example, the method 700 can be performed by a computing device having a computing architecture of the computing system 900 shown in FIG. 9.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces can be configured to communicate and/or receive wired and/or wireless data, including data according to the 3G, 4G, 5G, and/or other cellular standard, data according to the Wi-Fi (802.11x) standards, data according to the Bluetooth™ standard, data according to the IP standard, and/or other types of data.

The components of the computing device can be implemented in circuitry. For example, the components can include and/or can be implemented using electronic circuits or other electronic hardware, which can include one or more programmable electronic circuits (e.g., microprocessors, graphical processing units (GPUs), digital signal processors (DSPs), CPUs, and/or other suitable electronic circuits), and/or can include and/or be implemented using computer software, firmware, or any combination thereof, to perform the various operations described herein.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but may have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as RAM such as synchronous dynamic random access memory (SDRAM), ROM, non-volatile random access memory (NVRAM), EEPROM, flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more DSPs, general purpose microprocessors, an ASIC, FPGAs, or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

What is claimed is:

1. A method comprising:
collecting measurements from a plurality of sensors within a network device;
obtaining clock drift information from a machine learning (ML) model based on the measurements from the plurality of sensors and a clock signal of the network device, wherein the ML model is trained to determine a clock drift with reference to a reference clock;
generating a clock correction signal to correcting the clock signal using the clock drift information, wherein the clock signal is synchronized to the reference clock based on the clock correction signal; and
communicating with an external network device based on the clock signal.

2. The method of claim 1, wherein the plurality of sensors include at least one of a temperature sensor for detecting a temperature within the network device, a temperature sensor for detecting an ambient temperature of an environment, an acceleration sensor, and a humidity sensor.

3. The method of claim 1, wherein the ML model is untrained when the network device is brought online before an initialization period.

4. The method of claim 3, further comprising:
after the initialization period, receiving the reference clock on an interval; and
determining a clock drift between the reference clock and the clock signal.

5. The method of claim 4, further comprising:
determining a reward for the ML model based on the clock drift and a duration between synchronizations; and
training the ML model based on the reward.

6. The method of claim 1, wherein the ML model is trained using a Siamese training network.

7. The method of claim 1, wherein the reference clock is associated with a primary network device that determines the reference clock based on at least one signal from at least one satellite.

8. The method of claim 1, further comprising:
receiving validation information from a control plane or an end user, wherein the validation information includes at least one parameter that indicates that the ML model has completed an initialization period.

9. The method of claim 1, further comprising:
providing the clock correction signal to a local oscillator to synchronize the local oscillator with respect to the reference clock.

10. The method of claim 1, further comprising:
providing the clock correction signal to a clock generator to synchronize at least one clock signal to the reference clock.

11. A network device for performing a function, comprising:
at least one memory; and
at least one processor coupled to the at least one memory and configured to:
collect measurements from a plurality of sensors within a network device;
obtain clock drift information from a machine learning (ML) model based on the measurements from the plurality of sensors and a clock signal of the network device, wherein the ML model is trained to determine a clock drift with reference to a reference clock;
generate a clock correction signal to correcting the clock signal using the clock drift information, wherein the clock signal is synchronized to the reference clock based on the clock correction signal; and
communicate with an external network device based on the clock signal.

12. The network device of claim 11, wherein the plurality of sensors include at least one of a temperature sensor for detecting a temperature within the network device, a temperature sensor for detecting an ambient temperature of an environment, an acceleration sensor, and a humidity sensor.

13. The network device of claim 11, wherein the ML model is untrained when the network device is brought online before an initialization period.

14. The network device of claim 13, wherein the at least one processor is configured to:
after the initialization period, receive the reference clock on an interval; and
determine a clock drift between the reference clock and the clock signal.

15. The network device of claim 14, wherein the at least one processor is configured to:
determine a reward for the ML model based on the clock drift and a duration between synchronizations; and
train the ML model based on the reward.

16. The network device of claim 11, wherein the ML model is trained using a Siamese training network.

17. The network device of claim 11, wherein the reference clock is associated with a primary network device that determines the reference clock based on at least one signal from at least one satellite.

18. The network device of claim 11, wherein the at least one processor is configured to:
receive validation information from a control plane or an end user, wherein the validation information includes at least one parameter that indicates that the ML model has completed an initialization period.

19. The network device of claim 11, wherein the at least one processor is configured to:
provide the clock correction signal to a local oscillator to synchronize the local oscillator with respect to the reference clock.

20. The network device of claim 11, wherein the at least one processor is configured to:
provide the clock correction signal to a clock generator to synchronize at least one clock signal to the reference clock.
